(19) United States
(12) Patent Application Publication
(10) Pub. No.: US 2019/0046308 A1
(43) Pub. Date: Feb. 14, 2019

(54) TEETH CLEANING DEVICE

(71) Applicant: Brandon Cameron, Sherman Oaks, CA (US)

(72) Inventor: Brandon Cameron, Sherman Oaks, CA (US)

(21) Appl. No.: 15/673,154

(22) Filed: Aug. 9, 2017

(51) Int. Cl. A61C 17/26; A61C 17/34; A46B 7/08

(52) U.S. Cl. CPC A61C 17/26; A46B 9/045; A46B 7/08; A61C 17/34

(57) ABSTRACT

An electric toothbrush with the brush head in the form of a mouth guard is provided. The electric toothbrush generally includes a brush head configured into the form and shape of a mouth guard, and a handle coupled to the brush head. In some implementations, the handle may be detachable, or removable from the brush head. The brush head may include a liner of toothbrush bristles lining the inner walls and the base of the cavity of the brush head. In some implementations, the lining may be pre-fabricated together with the brush head. In other implementations, the lining may be changeable.

### TECHNICAL FIELD

The invention generally relates to a teeth cleaning device and, in particular, a teeth cleaning device in the form of a mouth guard.

### BACKGROUND

Dentists have been increasingly advising their patients of the benefits in using electric toothbrushes. An electric toothbrush makes fast, automatic but gentle bristle motions to clean teeth. The motions can either be back-and-forth oscillation or rotation-oscillation where the brush head alternates clockwise and counterclockwise rotation. The motions may be at sonic speeds or below and are made by a motor located in the handle of the electric toothbrush. In the case of ultrasonic toothbrushes, ultrasonic motions can be produced by a piezoelectric crystal. A modern electric toothbrush is usually powered by a rechargeable battery charged through inductive charging when the handle is placed in a charging base between uses.

Although the benefits of using electric toothbrushes are undisputed and well known, many people, especially children still have not used them. One reason for not using electric toothbrushes is their cumbersome operation. Yet for users with limited manual dexterity or where difficulty exists in reaching the rear teeth, both conditions applying to children, dentists have indicated that electric toothbrushes are especially beneficial. On the other hand, challenges related to using electric toothbrushes, for both children and adults, include inaccuracy of focusing on and maintaining the correct brushing motion in order to thoroughly clean each individual tooth as well as the gum line.

It is also common that while brushing, mostly in the bathroom, people may want to perform other tasks at the same time, for example, tying a tie, brushing hair, putting on make-up, scanning through a handheld phone, or tidying up the bathroom, and so on. With one hand being occupied with holding and using the toothbrush, performing another task is difficult.

It is therefore desirable to provide an electric toothbrush with a brush head in the form of a mouth guard that would make it easy, and even fun, to use, and that provides accuracy in brushing motion, hands-free, and other advantages heretofore unknown in the art.

### SUMMARY OF THE INVENTION

An electric toothbrush is provided. The electric toothbrush generally includes a brush head configured into the form and shape of a mouth guard, and a handle coupled to the brush head. In some implementations, the handle may be detachable or removable from the brush head. The brush head may include a cavity and a liner of toothbrush bristles lining the inner walls and the base of the cavity of the brush head. In some implementations, the lining may be pre-fabricated together with the brush head. In other implementations, the lining may be changeable or otherwise detachable from the brush head cavity.

Other devices, apparatus, systems, methods, features and advantages of the disclosure will be or will become apparent to one with skill in the art upon examination of the following figures and detailed description. It is intended that all such additional systems, methods, features and advantages be included within this description, and be protected by the accompanying claims.

### BRIEF DESCRIPTION OF THE FIGURES

The present invention may be better understood by referring to the following figures. The components in the figures are not necessarily to scale, emphasis instead being placed upon illustrating the principles of the disclosure. In the figures, like reference numerals designate corresponding parts throughout the different views.

FIG. 1A is a top perspective view of one example of an electric toothbrush in accordance with the teachings of the present disclosure.

FIG. 1B is a top perspective view of one example of another electric toothbrush in accordance with the teachings of the present disclosure.

FIG. 2A is a bottom perspective view of the electric toothbrush of FIG. 1A in accordance with the teachings of the present disclosure.

FIG. 2B is a bottom perspective view of the electric toothbrush of FIG. 1B in accordance with the teachings of the present disclosure.

FIG. 3A is a side view of the electric toothbrush of FIG. 1A in accordance with the teachings of the present disclosure.

FIG. 3B is a side view of the electric toothbrush of FIG. 1B in accordance with the teachings of the present disclosure.

FIG. 4A is a front view of one example of a brush head with a pre-fabricated liner in accordance with the teachings of the present disclosure.

FIG. 4B is a front view of a second example of a brush head with a pre-fabricated liner in accordance with the teachings of the present disclosure.

FIG. 5 is a front view of one example of a brush head with a changeable liner in accordance with the teachings of the present disclosure.

FIG. 6A is a top perspective assembly view of one example of a brush head and detachable handle in accordance with the teachings of the present disclosure.

FIG. 6B is a top view of a connecting neck portion of the detachable handle of the electric toothbrush of FIG. 6A in accordance with the teachings of the present disclosure.

FIG. 6C is a rear view of a segment of the brush head of the electric toothbrush of FIG. 6A in accordance with the teachings of the present disclosure.

FIG. 6D is a close-up top view of the connecting neck portion of the detachable handle of the electric toothbrush of FIG. 6A in accordance with the teachings of the present disclosure.

FIG. 6E is a rear view of another segment of the brush head of the electric toothbrush of FIG. 6A in accordance with the teachings of the present disclosure.

FIG. 6F is a top sectional view of a brush head of the electric toothbrush of FIG. 6A in accordance with the teachings of the present disclosure.

FIG. 7A is a rear view of a brush head of the electric toothbrush of FIG. 1B in accordance with the teachings of the present disclosure.

FIG. 7B is a close-up top view of a connecting neck portion of a detachable handle of the electric toothbrush of FIG. 1B in accordance with the teachings of the present disclosure.

FIG. 7C is a top sectional view of a brush head of the electric toothbrush of FIG. 1B in accordance with the teachings of the present disclosure.

FIG. 8 is a cut away schematic view of a handle of an electric toothbrush in accordance with the teachings of the present disclosure.

### DETAILED DESCRIPTION

The description of implementations below is presented for purposes of illustration. It is not exhaustive and does not limit the claimed invention to the precise forms disclosed. Modifications and variations are possible in light of the description below, or may be acquired from practicing the invention. The claims and their equivalents define the scope of the invention.

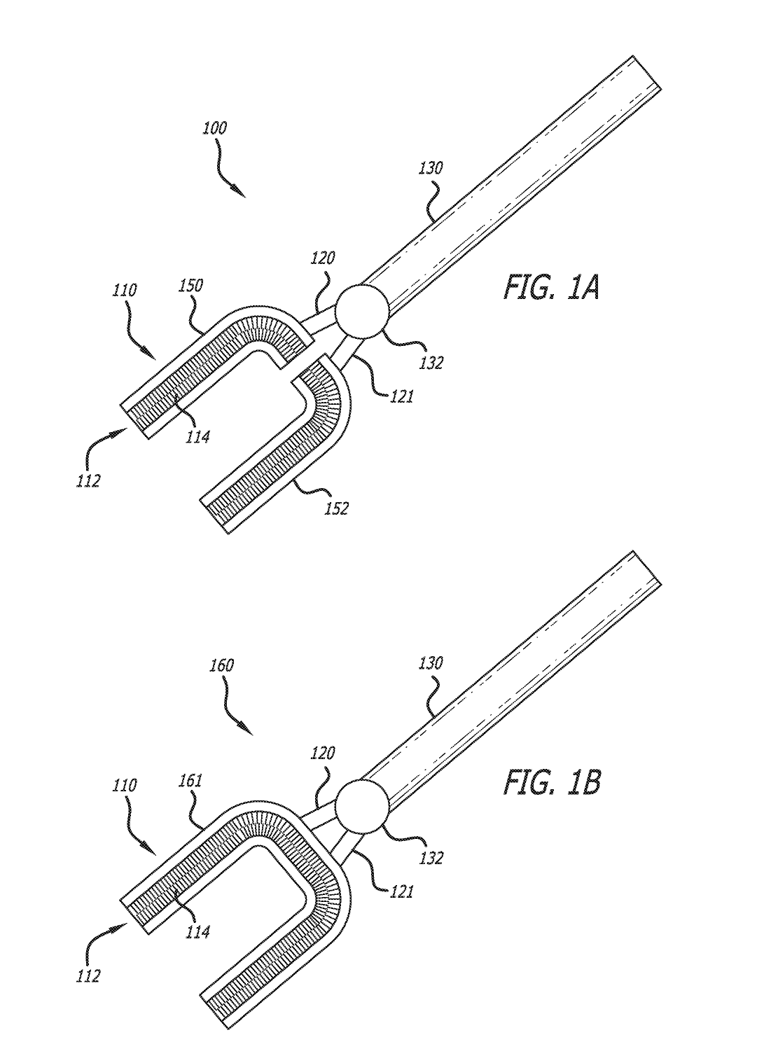

FIGS. 1-8 illustrate various implementations of an electric toothbrush according to the teachings of the present disclosure. The electric toothbrush generally includes a brush head and a handle. The brush head may be constructed to the form and shape of a mouth guard and the handle may be removeably coupled to the brush head. In some implementations, the handle may be detachable or removable from the brush head. In some implementations, the handle may be integrally formed with, or not detachable from the brush head. The brush head may include a hollowed cavity and a liner of toothbrush bristles lining the inner walls and floor of the cavity. In some implementations, the lining may be pre-fabricated together with the brush head. In other implementations, the lining may be changeable or otherwise detachable from the brush head cavity.

In some implementations, the brush head may be constructed to the form of a single contiguous U-shaped member. In other implementations, the brush head may include two separate member segments.

In some implementations, the brush head may be constructed to various dimensions and shapes. A user may select a brush head having dimensions and shape complimentary with his or her mouth and teeth.

In some implementations, the brush head may be made for the upper teeth only. In other implementations, the brush head may be made for the lower teeth only. In further implementations, the brush head may be constructed to brush both the upper teeth and the lower teeth at the same time.

In some implementations, the brush head may oscillate back-and-forth in a horizontal plane. When a user places the brush head into their mouth to cover their teeth, the user may activate the brush head oscillation motion, for example, with a control button located on the handle connected to the brush head. The brush head may then oscillate back-and-forth while still being positioned over the teeth. The oscillating motion may cause the bristles located inside the brush head to clean the teeth.

Turning to FIG. 1A, a top perspective view of one example of a brush head and handle 100, in accordance with the teachings of the present disclosure, is illustrated. The brush head and handle 100 is also referred to herein as electric toothbrush 100 for brevity. As shown, the electric toothbrush 100 generally include a brush head 110 and a handle 130. The brush head 110 may be constructed to a shape resembling a half-circle mouth guard with two separated segments 150 and 152. Each segment 150 and 152 may be constructed to extend from the central incisor to the “back” or third molar of the user.

The handle 130 includes connecting neck portions 120 and 121 at the proximal or front end of the handle where the connecting neck portions 120 and 121 are coupled to the corresponding segments 150 and 152 of the brush head 110.

The brush head 110 may be constructed of acrylic, ethyl vinyl acetate (EVA) dental plastic, multi-laminated plastic, PolyShok™, laminating PolyShok™, or any other suitable materials. The handle 130 may be constructed of acrylonitrile butadiene styrene (ABS) plastic, or any other suitable materials.

The brush head 110, with its construction of two separate segments 150 and 152, may advantageously provide flexibility for the brush head 110 to reach further into a user's mouth, thus reaching the user's back molars with more ease.

FIG. 1B illustrates another example of an electronic toothbrush 160 in accordance with the teachings of the present disclosure. In this example, the electronic toothbrush 160 includes a handle 130 and connecting neck portions 120 and 121 similar to the brush head and handle 100 shown in FIG. 1A. The electronic toothbrush 160 further includes a brush head 161. The brush head 161 may be constructed to a shape resembling a single contiguous half-circle. In this example, the brush head 161 is constructed to cover teeth along the entire maxillary or mandibular, extending from the left third molar to the right third molar of the user.

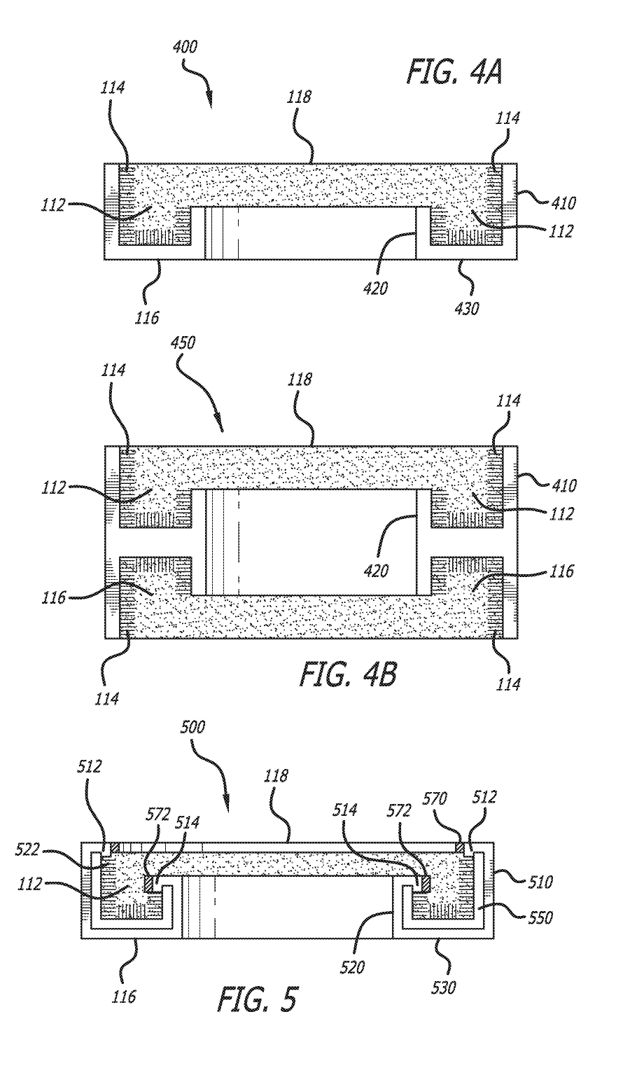

As will be described herein in FIGS. 4 and 5, in some implementations, the brush head 161 may be further constructed to a sectional U-shape along the length of the brush head, forming a cavity 112 therewithin. The cavity may include a lining of bristles, which may be referred to herein as lining 114. The bristles may be made of nylon, or any other suitable materials. It should be noted that while FIGS. 4 and 5 illustrate examples where the brush head is formed as a single contiguous half-circle shape (as shown in FIG. 1B), brush heads in implementations formed by two separate segments (for example, as shown in FIG. 1A) also include a cavity 112, lining 114, and other elements as shown.

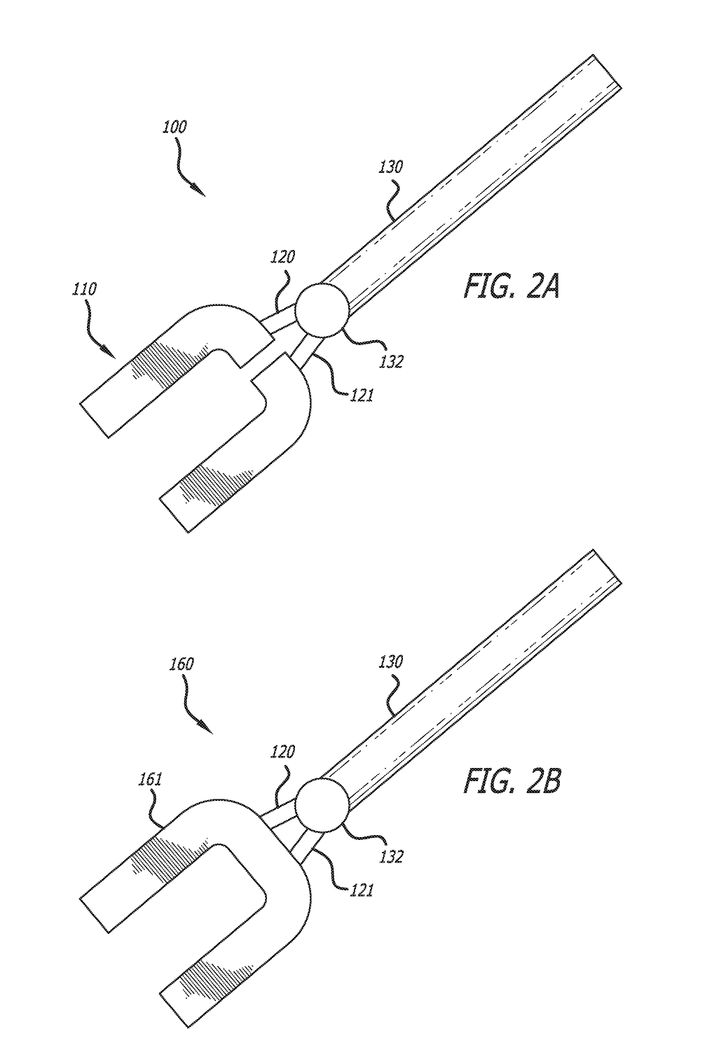

FIG. 2A illustrates a bottom perspective view of exemplary electronic toothbrush 100. FIG. 2B illustrates a bottom perspective view of exemplary electronic toothbrush 160.

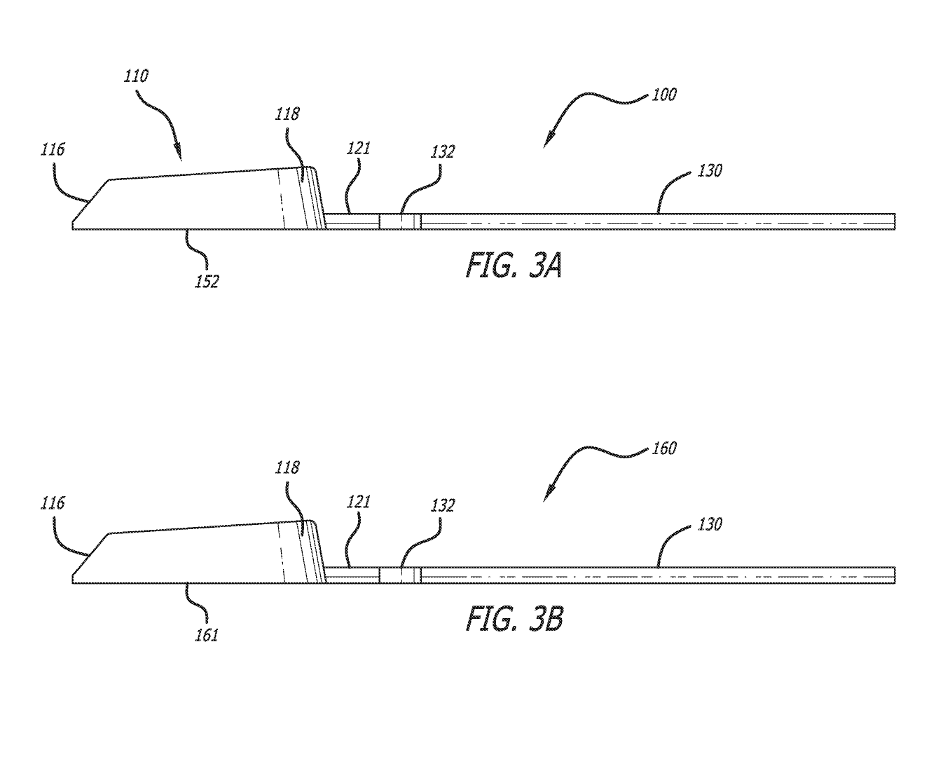

FIG. 3A illustrates a right side view of exemplary electronic toothbrush 100. As shown, in some implementations, the distal or rear end 118 of the brush head 110 may be constructed to a height greater than the height of the higher proximal or front end 116 of the brush head 110 such that the upper edge of brush head is tapered or slightly sloping downward from the distal (rear) end 118 toward the proximal (front) end 116. The downward slope is advantageously constructed to better fit into a user's mouth, where the lower proximal or front end 116 will be positioned further into the mouth.

Similarly, FIG. 3B illustrates a right side view of exemplary electronic toothbrush 160. As shown, in some implementations, the distal or rear end 118 of the brush head 110 may be constructed to a height greater than the height of the higher proximal or front end 116 of the brush head 110 such that the upper edge of brush head is tapered or slightly sloping downward from the distal (rear) end 118 toward the proximal (front) end 116. The downward slope is advantageously constructed to better fit into a user's mouth, where the lower proximal or front end 116 will be positioned further into the mouth.

FIG. 4 illustrates a front view of one example of a brush head 400 according to the teachings of the present disclosure. This particular brush head 400 may be used with the exemplary electronic toothbrush 160 shown in FIG. 1B. As shown, the brush head 400 may be constructed to have a U-shaped cross-section along the length of the brush head 400, forming a cavity 112. As shown in the example implementation of brush head 400, the U-shaped cross-section includes an outer wall 410, an inside wall 420, and a floor or base 430. In some implementations, the outer wall 410 may be constructed to a height greater than the inside wall 420. Such construction, as will be described further herein when the brush head 400 is positioned in a user's mouth and covers the user's teeth, advantageously allows for an easier and more comfortable operation, as the lower inside wall 420 may avoid abutting against the ceiling of the user's mouth. This construction may also advantageously allow the brush head 400 to brush the gum line of the user's mouth.

Brush head 400 illustrates an example of a brush head pre-fabricated, or integrated with the lining of bristles 114 which is integrated with, or otherwise adhered to, the inside surfaces of the cavity 112.

FIG. 4B is a front view of an alternative implementation of a brush head 450, where the brush head is constructed to brush both the upper and lower teeth at the same time. As shown, brush head 450 includes a substantially U-shaped upper cavity 112 and lower cavity 116, both lined with bristles 114. In other implementations, brush head 450 may be constructed to a shape resembling a half-circle mouth guard with two separated segments, similar to the examples shown in FIGS. 1A, 2A and 6A.

FIG. 5 illustrates a front view of another example of a brush head 500 according to the teachings of the present disclosure. As shown, the brush head 500 may be constructed to have a U-shaped cross-section along the length of the brush head 500, forming a cavity 112 therein. The U-shaped cross-section includes an outer wall 510, an inside wall 520, and a floor or base 530. In some implementations, the outer wall 510 may be constructed to a height greater than the inside wall 520. Such construction, when the brush head 500 is positioned in a user's mouth and covers the user's teeth, advantageously allows for an easier and more comfortable operation, as the lower inside wall 520 may avoid abutting against the ceiling of the user's mouth. This construction may also advantageously allow the brush head 500 to brush the gum line of the user's mouth.

Brush head 500 illustrates an example of a brush head adapted to receive a changeable liner 550. The changeable liner 550 may be lined with nylon bristles 522, which lines the inside surfaces of the liner 550.

As shown, the upper portion of the outer wall 510 may include a downward facing U-shape hook 512, and the upper portion of the inside wall 520 may include a downward facing U-shape hook 514. The hook 512 may be constructed to extend along the entire length of the outer wall 510. The hook 514 may be constructed to extend along the entire length of the inside wall 520. In some implementations, instead of a solitary hook 512 and 514 being integrally formed along the top portions of the on the outer and inner walls 510 and 520, respectively, two or more hook portions may be coupled to the outer wall 510 and inside wall 520 at various locations along the walls.

According to this implementation, the liner 550 may be snapped into the hooks 512 and 514. The hooks 512 and 514 may operate to receive the liner 550 and secure the liner 550 to the brush head 500.

The brush head 500 may include padding 570 that is coupled along the entire length of the hook 512, and padding 572 that is coupled along the entire length of the hook 514. In some implementations, the padding 570 and 572 may be constructed of a soft material, such as foam or rubber, and act to prevent the hooks 512 and 514 from striking or otherwise damaging the user's teeth.

As noted herein, while FIGS. 4 and 5 illustrate implementations of a brush head in the single contiguous half-circle shape, these implementations may similarly be constructed for the brush heads formed by two separate segments.

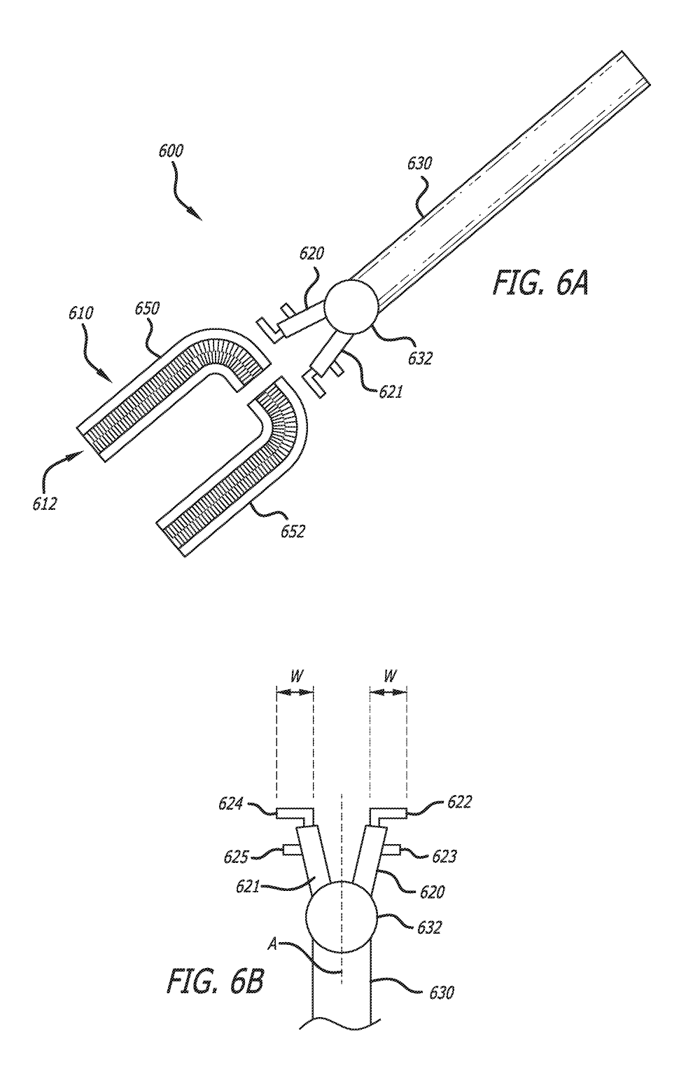

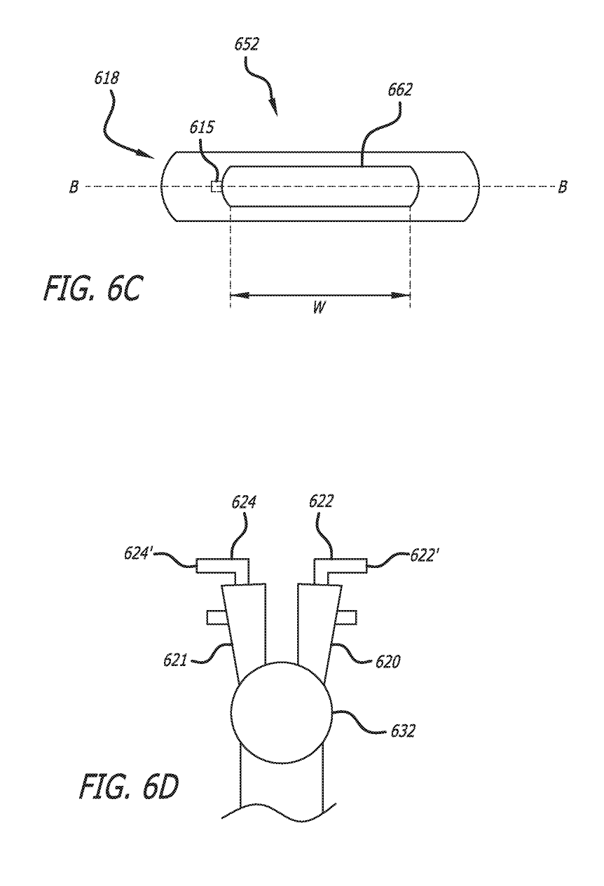

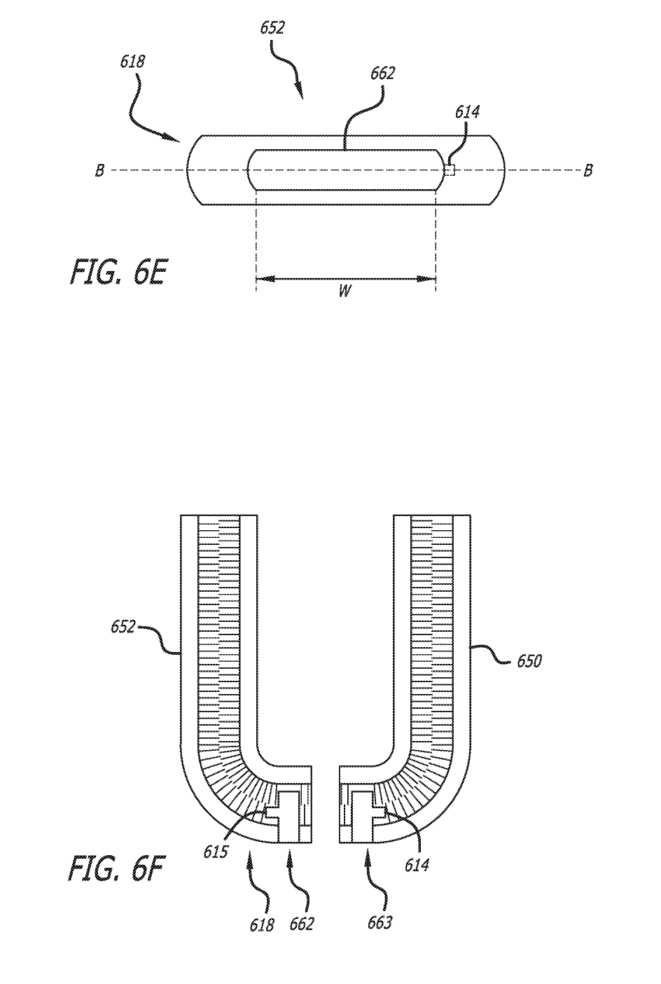

FIG. 6A illustrates a top perspective assembly view of another example of an electronic toothbrush 600 according to the teachings of the present disclosure. As shown, the electronic toothbrush 600 generally includes a brush head 610 and a handle 630. The brush head 610 is constructed to a shape resembling a half-circle mouth guard. In this example, the brush head 610 includes two separate segments 650 and 652. The brush head 610 is constructed to have a U-shaped cross-section along the length of the segments 650 and 652, forming a corresponding cavity 612. The handle 630 further includes connecting neck portions, or necks 620 and 621, and a rotating or pivoting connector 632 at the proximal or front end where the connecting neck portions 620 and 621 are coupled to the brush head segments 650 and 652 respectively. The handle 630 is also further constructed to be detachable from the brush head segments 650 and 652.

FIGS. 6B-6E illustrate an exemplary mechanism for attaching the handle 630 to and detaching the handle 630 from the brush head 610. FIG. 6B illustrates a top view of one example of the connecting neck portions 620 and 621 of the detachable handle 630, according the teachings of the present disclosure. As shown, the neck portions 620 and 621 may include moveable or retractable hooks 622 and 624 respectively, which may be retracted toward the center of the handle 630 when a user pushes on the corresponding tabs 623 and 625 respectively. The tabs 623 and 625 may be coupled to the corresponding retractable hooks 622 and 624 in such manner that when the tabs 623 and 625 are pushed inward and toward the center axis A of the handle 630, the corresponding retractable hooks 622 and 624 also retract inward and toward the center axis A of the handle 630.

FIG. 6C illustrates a rear view of one example of the segment 652 of the brush handle 610 when the segment 652 of the brush handle 610 is detached from the handle 630. This rear view is taken from the distal or rear end 618 (see FIG. 6A) of the segment 652. The distal or rear end 618 of the segment 652 may include an elongated aperture 662 having a width W that approximately matches the width W of the hook 624 (see FIG. 6B). The aperture 662 further includes aperture 615 sized to receive the hook 624. When the neck portion 621 is connected to the segment 652, the flange 624′ of the hook 624 (see FIG. 6D) engages with the aperture 615.

Similarly, FIG. 6E illustrates a rear view of one example of the segment 650 of the brush handle 610 when the segment 650 of the brush handle 610 is detached from the handle 630. This rear view is taken from the distal or rear end 618 (see FIG. 6A) of the segment 650. The distal or rear end 618 of the segment 650 may include an elongated aperture 663 having a width W that approximately matches the width W of the hook 622 (see FIG. 6B). The aperture 663 further includes aperture 614 sized to receive the hook 622. When the neck portion 620 is connected to the segment 650, the flange 622′ of the hook 622 (see FIG. 6D) engages with the aperture 614.

FIG. 6F illustrates a top sectional view of one example of the brush handle 610 along the line BB (FIG. 6C), in accordance with the teachings of the present disclosure. This figure shows the construction of the apertures 614 ad 615 formed in the segments 650 and 652 to receive the flanges 622′ and 624′ of the hooks 622 and 624.

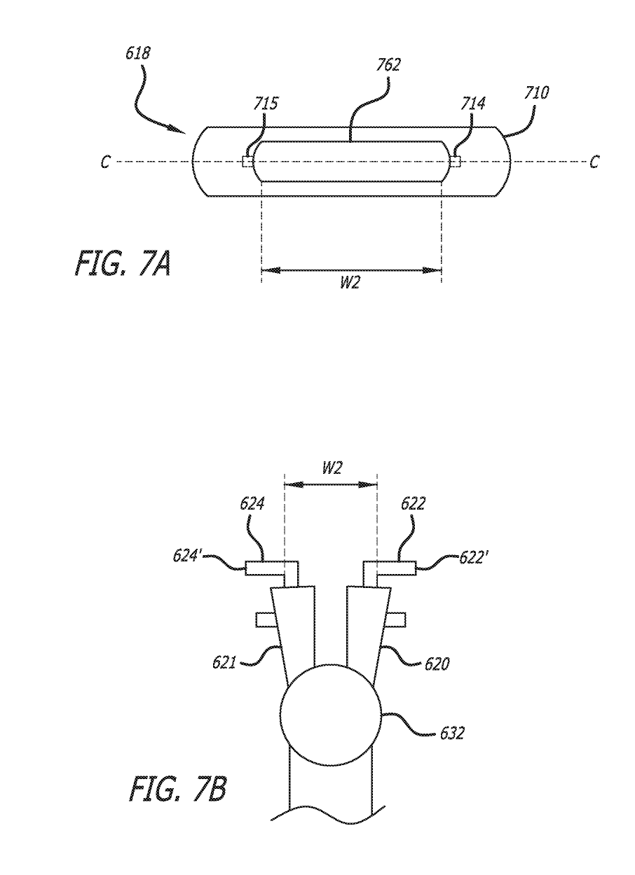

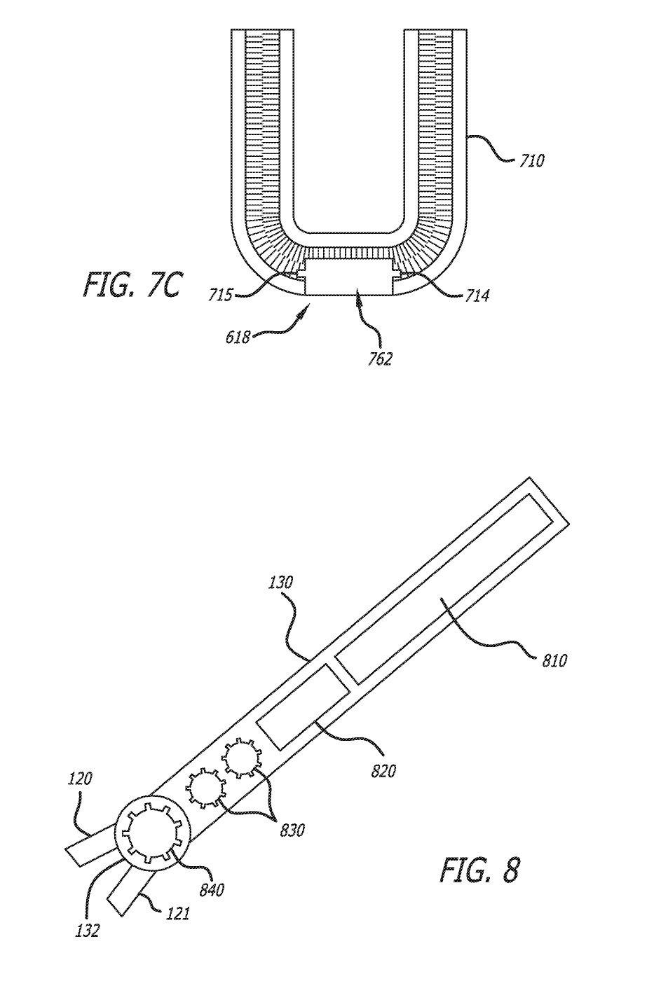

FIG. 7A illustrates a rear view of one example of a single contiguous brush head 710 according to the teachings of the present disclosure. This rear view is taken from the distal or rear end 618 of the brush head 710. As shown, the distal or rear end 618 of the brush head 710 may include an elongated aperture 762 having a width W2 that approximately matches the width W2 between the two hooks 622 and 624 (see FIG. 7B). The aperture 762 further includes apertures 714 and 715 sized to receive the hooks 622 and 624 of the neck portions 620 and 621 respectively. When the neck portions 620 and 621 are connected to the brush head 710, the flanges 622′ and 624′ of the hooks 622 and 624 (see FIG. 7B) engage with the apertures 714 and 715 respectively.

FIG. 7C illustrates a top sectional view of one example of the brush head 710 along the line CC (FIG. 7A), in accordance with the teachings of the present disclosure. This figure shows the construction of the apertures 714 ad 715 formed in rear end 618 of brush head 710 to receive the flanges 622′ and 624′.

It should be noted that the brush heads 610 and 710 may be constructed similar to brush head 110, as described herein, to include either an integrated lining of bristles 114, or a changeable liner 550 lined with bristles. Brush heads 610 and 710 may also be constructed to include a taper that slopes downward from the rear end toward the front end of the brush head, similar to brush head 110.

It should also be noted that, in some implementations, the brush heads 110, 610 and 710 may be constructed to fit the upper teeth only. In some implementations, the brush heads 110, 610 and 710 may be constructed to fit the lower teeth only. In other implementations, the brush heads 110, 610 and 710 may be constructed to fit either the upper teeth or the lower teeth.

FIG. 8 illustrates a top cut away view of one example of a handle portion 130 according to the teachings of the present disclosure. The handle 130 may include an inner housing that houses a power source 810, for example, a battery, electronics 820 (including electronic circuitry and motor), and one or more sprockets 830. The rotating connector 132 may include a housing containing a sprocket 840. As described herein, the battery provides power for the electronics 820, which operates to rotate the one or more sprockets 830 in a reciprocal manner. The sprockets 830 in turn rotate the sprocket 840, which causes the connector 132 to oscillate back-and-forth. As the connector 132 oscillates, it causes the connecting necks 120 and 121 to oscillate. When the connecting necks 120 and 121 are connected to a brush head as described herein, as the connecting necks 120 and 121 oscillate, they cause the brush head to oscillate back-and-forth.

In some exemplary operations, a user may first charge the power source 810. The user may then place the brush head 110, 610 or 710 into his/her mouth such that the cavity 112 or 612 fits over their teeth. As described herein, in some implementations, the brush head 110, 610 or 710 may fit over the upper teeth only, the lower teeth only, or either the upper or the lower teeth. The user may then the electronics 820 by, for example, pushing a button provided on the handle 130 or 630. Once activated, the brush head 110, 610 or 710 oscillates back-and-forth in a horizontal plane. In some implementations, the brush head 110, 610 or 710 may oscillate at a desired speed. The oscillating motion causes the bristles inside the cavity 112 or 612 to brush against the t0eeth. In some uses, the bristles may also brush against part of the gum closest the base of the teeth.

It is noted that while operating the electronic toothbrush, the user may be hands free. With the brush head securely operating inside the mouth, it provides accuracy of focusing on and maintaining the correct brushing motion in order to thoroughly clean each individual tooth as well as the gum line.

Electric toothbrushes can be classified, according to the frequency (speed) of their movements, as sonic or ultrasonic toothbrushes depending on whether they make movements that are below, in or above the audible range (e.g., 20-20,000 Hz or 2400-2,400,000 movements per minute), respectively. In some implementations, the brush head and handle described herein may not operate higher than the lowest sonic speed or 2400 movements per minute. These implementations may be used, for example, for brush heads used by children. In some implementations, the speed may be substantially lower, for example, approximately 1000 revolutions per minute, which will help with overall product wear and tear. The hands free brush head and handle may also be available in other implementations to achieve sonic movements to help with removing additional plaque for adults.

In some exemplary operations, the user may advantageously remove the changeable liner and replace it with another, for example, newer liner.

In yet some other exemplary operations, the user may advantageously detach the handle from the brush head, for example, for storage. As described herein, see for example FIGS. 6A-6E, to detach the handle 630, the user pushes or squeezes on the buttons 623 and 625 on the neck portions 620 and 621 respectively. This causes the flanges 622′ and 624′ to retract and disengage from the apertures 614 and 615 of the brush head 610 respectively, which in turn causes the neck portions 620 and 621 and the handle 630 to be freely released from the brush head 610.

The handle may be sealed to prevent water from entering the inner housing. In some implementations, the power source includes one or more rechargeable battery. In some implementations, the handle may include metal tabs to connect to a charging base. In other implementations, the handle does not include metal tabs as the rechargeable battery may be charged using contactless inductive charging.

In general, terms such as “coupled to,” and “configured for coupling to,” and “secured to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. An electric toothbrush comprising:
a brush head constructed to a form and shape of a mouth guard, the brush head comprising a sectional cavity defined by a pair of inner walls and a base; and
a handle coupled to the brush head;
wherein the brush head includes a liner of toothbrush bristles lining the inner walls and the base of the sectional cavity thereof.

2. The electric toothbrush of claim 1, wherein the handle is integrally formed with the brush head.

3. The electric toothbrush of claim 1, wherein the handle is detachable from the brush head.

4. The electric toothbrush of claim 1, wherein the liner of toothbrush bristles is affixed to the brush head.

5. The electric toothbrush of claim 1, wherein the liner of toothbrush bristles is detachable from the brush head.

6. The electric toothbrush of claim 1, wherein the handle further includes an inner housing including one or more electronics components, one or more sprockets, and a power source.

7. The electric toothbrush of claim 1, wherein the handle further includes one or more neck portions and a rotating connector.

8. The electric toothbrush of claim 7, wherein each of the one or more neck portions includes one or more buttons coupled to one or more corresponding retractable hooks.

9. The electric toothbrush of claim 8, wherein the brush head further includes a first elongated aperture.

10. The electric toothbrush of claim 9, wherein the first elongated aperture further includes one or more second apertures sized to receive the one or more retractable hooks.

11. The electric toothbrush of claim 1, wherein the brush head oscillates back-and-forth in a horizontal plane.

12. The electric toothbrush of claim 1, wherein the brush head includes two separate segments.

13. The electric toothbrush of claim 1, wherein the brush head includes a single contiguous half-circle segment.

14. An electric toothbrush comprising:
a brush head constructed to a form and shape of a mouth guard, the brush head comprising two separated segments having a sectional cavity defined by a pair of inner walls and a base; and
a handle removably coupled to the brush head, the handle including two neck portions and a rotating connector;
wherein each segment of the brush head includes a liner of toothbrush bristles lining the inner walls and the base of the sectional cavity thereof, and wherein the brush head oscillates back-and-forth in a horizontal plane.

15. The electric toothbrush of claim 14, wherein the liner of toothbrush bristles is affixed to the brush head.

16. The electric toothbrush of claim 14, wherein the liner of toothbrush bristles is detachable from the brush head.

17. The electric toothbrush of claim 14, wherein the handle further includes an inner housing including one or more electronics components, one or more sprockets, and a power source.

18. The electric toothbrush of claim 14, wherein each of the one or more neck portions includes one or more buttons coupled to one or more corresponding retractable hooks.

19. The electric toothbrush of claim 18, wherein each segment of the brush head further includes a first elongated aperture.

20. The electric toothbrush of claim 19, wherein the first elongated aperture further includes one or more second apertures sized to receive the one or more retractable hooks.
